(19) United States
(12) Patent Application Publication
(10) Pub. No.: US 2026/0236520 A1
(43) Pub. Date: Aug. 13, 2026

(54) CHANNEL GENERATION METHOD AND DEVICE FOR CLASSIFYING ACADEMIC LITERATURES BASED ON EMBEDDING VECTORS AND LARGE LANGUAGE MODELS

(71) Applicant: NT Parameter Lab GmbH, Tuebingen (DE)

(72) Inventors: Seong Joon OH, Tuebingen (DE); Young Wha PARK, Sulzbach (Taunus) (DE)

(21) Appl. No.: 19/231,179

(22) Filed: Jun. 6, 2025

(30) Foreign Application Priority Data
Feb. 13, 2025 (KR) 10-2025-0018996

(51) Int. Cl. G06F 16/35

(52) U.S. Cl. CPC G06F 16/35

(57) ABSTRACT

A connection channel generation method includes: acquiring, by a connection channel generation device, at least one academic literature published on a registered website; extracting, by the connection channel generation device, text from a file of a first academic literature among the at least one academic literature; classifying, by the connection channel generation device, the extracted text according to individual sections; inputting, by the connection channel generation device, data of a first section into a first large language model to generate a first embedding vector value; determining, by the connection channel generation device, a category of the first academic literature based on the first embedding vector value; and generating, by the connection channel generation device, a connection channel for a first user associated with the first academic literature based on the determined category of the first academic literature.

### CROSS-REFERENCE TO RELATED APPLICATION

This application is based on and claims priority under 35 U.S.C. § 119 to Korean Patent Application No. 10-2025-0018996, filed on Feb. 13, 2025, in the Korean Intellectual Property Office, the disclosure of which is incorporated by reference herein in its entirety.

### BACKGROUND

### 1. Field

One or more embodiments relate to a connection channel generation device, a method for generating a connection channel, and a computer program stored on a storage medium for executing said method, and more particularly, to a technology that analyzes academic literature data to derive research relationships among researchers and generates a connection channel between authors.

### 2. Description of the Related Art

Artificial intelligence AI technology is a core field that drives innovation across various industries in modern society and is advancing rapidly on a daily basis. The progress of AI technologies is being achieved in diverse areas such as novel algorithms, data processing techniques, hardware architectures, and real-world applications. To support these advancements, researchers continuously publish academic literatures. In particular, thousands of AI-related literatures are released and are regarded as essential resources by both academia and industry.

Such academic literatures are critical for understanding the latest trends in AI technology, conducting new research, and maintaining competitive advantage in the field. However, due to the sheer volume of publications—numbering in the thousands each month—it is practically impossible to review all relevant literatures, given the limitations of time and human resources.

Moreover, AI-related documents often contain highly technical content, requiring substantial expertise and time to fully comprehend. Consequently, identifying and analyzing literatures that are directly relevant to one's research or business objectives demands significant effort.

Therefore, there is a growing need among AI developers, researchers, and companies for tools and methods that can efficiently review large volumes of academic material and rapidly extract relevant information. In particular, there is an increasing demand for technologies that can effectively manage, analyze, and summarize vast collections of academic literatures.

### SUMMARY

According to the connection channel generation device, method, and computer program stored on a storage medium for executing said method described above, each user is supported in forming interpersonal networks automatically by providing collaboration tools within a group based on the respective user's research characteristics.

In addition, the connection channel generation device, method, and computer program allow users to be grouped into predetermined groups based on their respective research achievements. Trend data for each group can be generated and provided, thereby enabling the tracking and visualization of changes in academic literatures specific to each group.

However, such a technical problem is an example, and the objective of disclosure to solve is not limited thereto.

Additional aspects will be set forth in part in the description which follows and, in part, will be apparent from the description, or may be learned by practice of the presented embodiments of the disclosure.

According to one embodiment of the disclosure, the method includes: obtaining, by the connection channel generation device, one or more academic literatures published on a registered website; obtaining text included in a file of a first academic literature among the one or more academic literatures, classifying the text by each item, and inputting data of a first item into a first large language model to output a first embedding vector value; determining a category of the first academic literature based on the first embedding vector value; and generating a connection channel for a first user associated with the first academic literature based on the determined category.

The generating the connection channel may include identifying a second user having a research relationship with the first user, and automatically generating a connection channel between the first and second users.

The determining the category may include comparing the first embedding vector value with one or more representative embedding vector values for each category, and selecting the category of the representative embedding vector value having a distance equal to or less than a predetermined threshold as the category of the first academic literature.

The outputting the first embedding vector value may include inputting data of a second item of the first academic literature into a second large language model to output a second embedding vector value, and generating a final embedding vector value by applying weighted values to the first and second embedding vector values.

The method may further include executing a separate program that provides at least one service among video conferencing, webinars, messaging, and collaboration tools between the terminals of the first and second users through the generated connection channel.

The method may further include receiving a connection channel generation request from a third user having no research relationship with the first user, and transmitting an approval request for the connection based on a service level of the third user.

According to one embodiment of the disclosure, the device may include a processor, memory, and a communication module, wherein the processor is configured to: obtain one or more academic literatures from a registered website; obtain and classify the text from a file of a first academic literature; input data of a first item into a first large language model to output a first embedding vector value; determine the category of the academic literature based on the embedding vector; and generate a connection channel for a first user associated with the document.

The processor may be further configured to identify a second user having a research relationship with the first user and automatically generate a connection channel between them.

The processor may be configured to determine the category by comparing the embedding vector with category-specific representative vectors and selecting a category with a distance not exceeding a preset threshold.

The processor may be configured to output a final embedding vector value by inputting data of a second item into a second large language model to produce a second embedding vector and applying weights to the two vectors.

The processor may execute a separate program to provide services such as video conferencing, webinars, messaging, or collaboration tools between terminals of the first and second users.

The processor may also receive a connection request from a third user not related to the first user and transmit an approval request based on the service level of the third user.

In addition, other methods, systems, and computer-readable recording media for executing the method may also be provided for implementing the present invention.

Other aspects, features, and advantages of the invention will become apparent from the drawings, claims, and the detailed description below.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a network environment of a channel knowledge management system according to embodiments of the present disclosure.

FIG. 2 is a block diagram of a connection channel generation device according to embodiments of the present disclosure.

FIG. 3 is a diagram showing an example of data obtained from academic literatures.

FIG. 4 is a diagram illustrating a connection channel between multiple users belonging to two groups.

FIG. 5 is a diagram illustrating a service provided through a first connection channel.

FIG. 6 is a diagram showing an example user interface of a user list.

FIG. 7 is a diagram showing an example user interface with category display according to embodiments of the present disclosure.

FIG. 8 is a diagram illustrating an example of trend data provided according to embodiments of the present disclosure.

FIG. 9 is a flowchart illustrating a method of determining identity among authors according to embodiments of the present disclosure.

### DETAILED DESCRIPTION

Reference will now be made in detail to embodiments, examples of which are illustrated in the accompanying drawings, wherein like reference numerals refer to like elements throughout. In this regard, the embodiments of the present disclosure may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure may have various modifications and various embodiments, and specific embodiments are illustrated in the drawings and are described in detail in the detailed description. However, this is not intended to limit the disclosure to particular embodiments, and it will be understood that all changes, equivalents, and substitutes that do not depart from the spirit and technical scope of the disclosure are encompassed in the disclosure. In the description of the disclosure, even though elements are illustrated in other embodiments, like reference numerals are used to refer to like elements.

Hereinafter, embodiments of the disclosure will be described in detail with reference to the accompanying drawings, and in the following description with reference to the drawings, like reference numerals refer to like elements and redundant descriptions thereof will be omitted.

Although the terms “first,” “second,” etc. may be used to describe various elements, these elements should not be limited by these terms. These terms are only used to distinguish one element from another.

An expression used in the singular encompasses the expression of the plural, unless it has a clearly different meaning in the context.

It will be understood that the terms “comprise,” “comprising,” “include” and/or “including” as used herein specify the presence of stated features or elements but do not preclude the addition of one or more other features or elements.

Sizes of elements in the drawings may be exaggerated or reduced for convenience of explanation. In other words, because sizes and thicknesses of elements in the drawings are arbitrarily illustrated for convenience of explanation, the disclosure is not necessarily limited thereto.

The x-axis, the y-axis and the z-axis are not limited to three axes of the rectangular coordinate system, and may be interpreted in a broader sense. For example, the x axis, the y axis, and the z axis may be perpendicular to one another or may represent different directions that are not perpendicular to one another.

In the case where a certain embodiment may be implemented differently, a specific process order may be performed in the order different from the described order. As an example, two processes that are successively described may be substantially simultaneously performed or performed in the order opposite to the order described.

The terms used herein are only used to describe particular embodiments and are not intended to limit the scope of the disclosure. It will be understood that the terms “comprise,” “comprising,” “include” and/or “including” as used herein specify the presence of stated features, numbers, steps, operations, elements, parts, and combinations thereof, but do not preclude in advance the presence or addition of one or more other features, numbers, steps, operations, elements, parts, combinations thereof.

As used herein, terms such as “learning” or “training” refer not to mental activity akin to human education but to machine learning through computational procedures.

In the following embodiments, the term “user” may be used interchangeably with “author,” referring to an account associated with a user who accesses the connection channel generation device.

A large language model LLM, as referred to herein, is an AI model trained on large volumes of text data to understand and generate natural language. LLMs are typically based on artificial neural networks, particularly Transformer architectures. Examples of such models include OpenAI's GPT series, Google's BERT and PaLM, and Meta's LLaMA.

As used herein, the term “name classification model” refers to an artificial intelligence-based model configured to identify, classify, and normalize author name data extracted from academic literatures.

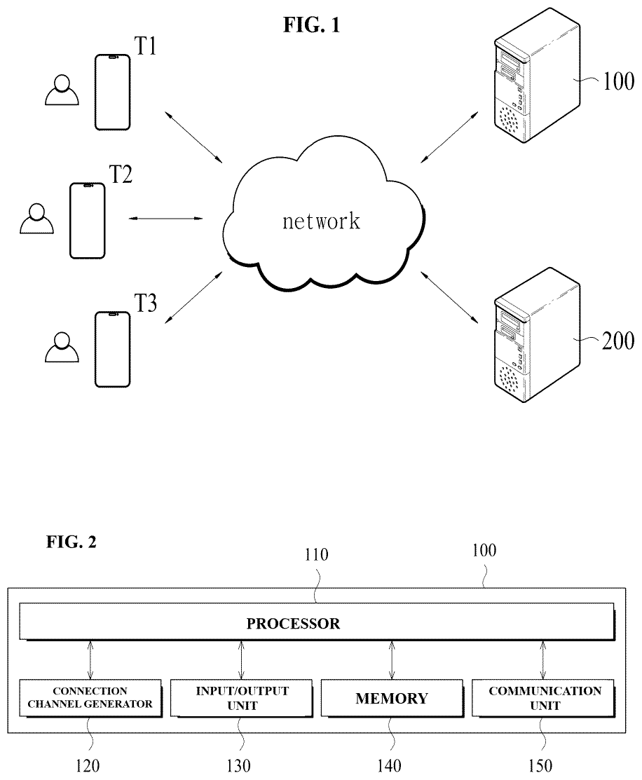

FIG. 1 illustrates a connection channel generation network system 1 according to an embodiment of the present disclosure. The system includes a connection channel generation device 100, an external server 200, and user terminals including a first user terminal T1, a second user terminal T2, and a third user terminal T3.

According to the embodiments of the present disclosure the connection channel generation device 100 may collect academic literatures disclosed on web pages, etc., analyze the collected academic literatures, and manage the analyzed data as big data. The connection channel generation device 100 uses big data to determine whether there is a match in the research relationships between registered users and, based on the match, may generate groups of users. The connection channel generation device 100 may provide communication functions between users within a group by setting up at least one connection channels that include users within the group. The connection channel generation device 100 may communicate with the external server 200 over a network and obtain data uploaded to or displayed by the external server 200.

The connection channel generation device 100 may provide big data to at least one of a first user terminal T1, a second user terminal T2, and a third user terminal T3 connected through the network. The connection channel generation device 100 may set up a connection channel between the first user terminal T1 and the second user terminal T2 included in a group, and provide video conferencing, web seminars, messaging, collaboration tools, etc., between the first user terminal T1 and the second user terminal T2 through the connection channel. The connection channel generation device 100 may provide video conferencing, web seminars, messaging, collaboration tools, etc., using an external separate platform. The first user terminal T1, the second user terminal T2, and the third user terminal T3 are electronic devices that include communication modules, processors, memory, etc. For example, the first user terminal T1, the second user terminal T2, and/or the third user terminal T3 may be smartphones, tablets, laptops, desktop computers, smartwatches, smart TVs, game consoles, IoT devices, automobiles, drones, wearable devices, industrial devices, etc. The communication module may include short-range communication modules e.g., Bluetooth, Wi-Fi, NFC, Zigbee, Infrared, UWB, mid-range modules e.g., Wi-Fi Mesh Networks, WiMAX, LoRa, mobile communication modules e.g., 2G, 3G, 4G, 5G, Satellite Communication, wired communication modules e.g., Ethernet, fiber optic, DSL, long-distance communication modules e.g., satellite, HF/VHF/UHF radio, microwave, military, maritime, or aviation communication modules.

The external server 200 is an electronic device that provides a service searching academic literature and may include a communication module, processor, and memory. The external server 200 may run a server program that provides data in response to client requests and may be, for example, a web server, cloud server, database server, proxy server, or DNS server.

In the connection channel generation network environment 1, the connection channel generation device 100 may access the external server 200 to obtain newly published academic literature data and determine a category representing the research relationship based on the acquired data. The device 100 may classify users (i.e., authors) of the academic literatures into at least one groups according to the determined categories. Categories may include upper and lower categories. The device may generate a group corresponding to a upper category and generate a group corresponding to a lower category included in the upper category. The lower category group may be included in the upper category group. The connection channel generation device 100 sets up at least one connection channels between users belonging to a group and provides services such as video conferencing, web seminars, messaging, and collaboration tools through these connection channels. The connection channel creation device 100 may provide services and information differentially based on ranks of users within the group. The connection channel generation device 100 may provide a subscription service that allows a user to establish a connection channel with other user in at least one group to which the user does not belong. The connection channel generation device 100 may provide a subscription service that provides information (such as academic literature and authors) about groups.

The device 100 may determine categories representing research relationships among academic literatures using a large language model LLM. An LLM corresponding to a first technical field may be a model trained through a fine-tuning process using academic literatures belonging to that field. The LLMs may be trained using academic literatures organized by at least one fields. The LLMs may generate structured data from titles, abstracts, and body texts included academic literatures and input the structured data. LLMs may input academic literature and output embedding vectors of the academic literatures. The connection channel generation device 100 may determine a category of an academic literature by additionally considering biographical information related to the academic literature. Biographical information may include authors. According to the embodiments of the present disclosure, the connection channel generation device 100 may provide collaboration tools within a group by considering a research characteristics of each user, thereby providing collaboration tools that help each user form networks. The research characteristics of the user may include information about at least one academic literatures published by the user, a group of the user and/or at least one categories of at least one academic literatures.

The connection channel generation device 100 may obtain the published first academic literature, register the first academic literature as a research performance of a user who is an author of the first academic literature, and group the users into predetermined groups in consideration of a research performance. The connection channel generation device 100 may aggregate the research performance of one or more users belonging to each group and generate and provide trend data for the group, thereby providing the change status of the academic literature by group as trend data. The trend data for a group may include a change in the number of academic literatures published by one or more users belonging to the group, an average value of the number of authors of the academic literatures, an average value of the quality of the academic literatures, a change in the number of users belonging to the group, and the like. The research performance may include a change in the number of academic literatures published by a user.

FIG. 2 illustrates a block diagram of the connection channel generation device 100 according to an embodiment of the present disclosure.

The connection channel generation device 100 may include a processor 110, a connection channel generator 120, an input/output unit 130, a memory 140, and a communication unit 150.

The processor 110 may be a hardware-embedded data processing device having physically structured circuits to perform functions expressed as code or instructions included in a program. Examples of such data processing devices include, but are not limited to, microprocessors, central processing units CPUs, processor cores, multiprocessors, application-specific integrated circuits ASICs, and field programmable gate arrays FPGAs.

The input/output unit 130 may display an interface generated by the memory 140. According to an embodiment, the input/output unit 130 may display a user interface in response to user input. The input/output unit 130 may output stored graphic, visual, audio, or haptic data under the control of the memory 140.

The input/output unit 130 may be implemented using various types of display panels such as LCDs, OLEDs, AM-OLEDs, LCoS, or DLP technologies. It may also be implemented as a flexible display covering at least one of a front, side, or rear areas of the device.

The memory 140 functions to temporarily or permanently store data processed by the connection channel generator 100. The memory 140 may include magnetic storage media or flash storage media, but the scope of the present disclosure is not limited thereto. For example, the memory 140 may temporarily and/or permanently store data (e.g., coefficients) comprising the artificial neural network. The memory 140 can also store training data for training the artificial neural network. The communication unit 150 may include hardware and software necessary to transmit and receive signals, such as control or data signals, to and from other network devices via wired or wireless connections. The connection channel generator 120 may be implemented as software and included in the connection channel generation device 100. The connection channel generator 120 may establish a connection channel between users, taking into account a matching of research relationships between the users. For example, the connection channel generation device 100 may retrieve and analyze data on the research relationship of a first user and a second user. Without directly establishing a relationship between the first user and the second user, the connection generation device 100 determine whether the research relationship between the first user and the second user matches based on the data obtained as a result of the retrieval and analysis, and establish a connection channel between the first user and the second user if the research relationship between the first user and the second user is determined to exist. The research relationship between the first user and the second user may be determined based on an academic literature of the first user and an academic literature of the second user. The research relationship between the first user and the second user may be determined based on an embedding vector of the first user's academic literature and an embedding vector of the second user's academic literature. The research relationship between the first user and the second user may be determined based on a distance value and/or a cosine value between the embedding vector of the first user's academic literature and the embedding vector of the second user's academic literature. The connection channel generator 120 may receive a request for generating a connection channel with the first user from a third user who does not have a research relationship with the first user. The connection channel generator 120 may send an authorization request in accordance with the connection channel generation request in consideration of a service level of the third user. The service level of the third user may be determined as one of ‘Basic’, ‘Pro’, or ‘Advanced’ based on the third user's periodic payment information. Approval of a request to create a connection channel with a user with whom there is no research relationship may be processed only if the service level is at the specified level. The connection channel generator 120 may access one or more web pages to acquire data on academic literatures publicly disclosed. A list of the one or more web pages may be pre-registered and managed per technical field.

Information about the one or more web pages is registered by the administrator and may be changed by adding or deleting information. Information about the one or more web pages may be stored and managed by technical field. For example, information of the one or more web pages for a first technical field, information of the one or more web pages for a second technical field, etc. may be stored and managed separately. The connection channel generator 120 may download a file (e.g., a PDF) of academic literature. The connection channel generator 120 may acquire, obtain, or extract a text data contained in the file using techniques such as OCR. The connection channel generator 120 may categorize and store text contained in the file by each item. The items to be categorized may be at least one of a title, a summary, a body, biographical information and so on. The items to be categorized may vary depending on the text in the file.

The connection channel generator 120 may store data of the first academic literature obtained in a format that is divided into items of title, summary, body, and author information. The connection channel generator 120 may train its own LLM (large language model) with the items of at least one academic literature. The connection channel generator 120 may fine-tune the LLM by inputting a newly obtained data into the LLM. The connection channel generator 120 may fine-tune a LLM of a summary data by inputting data for each item into the LLM separately. The LLM may include a first LLM fine-tuned with summary data, a second LLM fine-tuned with title data, and a third LLM fine-tuned with body data. The connection channel generator 120 may determine a first category of the first academic literature using the LLM including the one or more models.

The connection channel generator 120 may input data for the first academic literature into the LLM to output at least one embedding vector values. The connection channel generator 120 may input summary data of the first academic literature into the first LLM to output a first embedding vector value. The connection channel generator 120 may input the title data of the first academic literature into the second LLM and output a second embedding vector value. The connection channel generator 120 may input body data of the first academic literature into a third LLM and output a third embedding vector value. The connection channel generator 120 may compare the first embedding vector value with a preset category-specific embedding vector value set for the summary data. The connection channel generator 120 may determine a category with the embedding vector value that has the closest distance value to the first embedding vector value as first category of a first academic literature. The connection channel generator 120 may compare the second embedding vector value with a preset category-specific embedding vector value set for the title data. The connection channel generator 120 may determine a category with the embedding vector value that has the closest distance value to the second embedding vector value as second category of the first academic literature. The connection channel generation part 120 may compare the third embedding vector value with the category-specific embedding vector value preset for the text data. The connection channel generator 120 may determine a category with the embedding vector value that has the closest distance value to the first embedding vector value as third category of the first academic literature. The connection channel generator 120 may determine the first category corresponding to the first embedding vector value, the second category corresponding to the second embedding vector value, and the third category corresponding to the third embedding vector value as the category of the first academic literature. In another embodiment, the connection channel generator 120 may weight average the first to third embedding vector values to output a final embedding vector value, and determine a category of the first academic literature based on a final embedding vector value.

In another embodiment, the connection channel generator 120 may compare the embedding vector values of the academic literature to a category-specific embedding vector, The connection channel generator 120 may determine a category of the category-specific embedding vector having a distance value below a predetermined minimum difference value as a category of the first academic literature. Here, the category-specific embedding vector value may be determined as an average of the embedding vector values of at least one academic literature belonging to a category. The category-specific embedding vector value of a category may be determined based on categorizing at least one academic literature into respective categories. The category-specific embedding vector value of a category may be determined by the embedding vector values of the academic literatures belonging to the category.

In another embodiment, the connection channel generator 120 may output a second category of the first academic literature using a name classification model. The name classification model may extract name information of one or more authors of the first academic literature. The name classification model may store name information of at least one authors.

The name classification model may search for at least one authors with a same name as a first author. The name classification model may determine an author matching the first author among the at least one authors. The name classification model may determine the matching author by considering at least one academic literature of the first author, at least one co-authors of the first author, an abbreviated name of the first author, an email address of the first author, and an affiliation of the first author. The name classification model may classify the first author as the same as the matching author.

In another embodiment, the name classification model may perform a process of normalizing information of the first author if an author is not the same as the first author of the first academic literature. The process of normalizing may be performed through a normalization function. The normalization function may extract co-author information form at least one academic literature including the first author. The normalization function may search at least one academic literature having an author identical to the co-author information. The normalization function may identify whether there is an author similar to the first author among the author information of the at least one academic literature. The normalization function may measure a similarity between the first author and author information of the at least one academic literature. Here, the similarity between authors may be determined by considering whether authors have a same name (middle name, first name), whether authors have a name that includes a same abbreviation, whether authors have a same email address, whether authors have a same group, whether authors have a same co-author, whether a distance of embedding vector values is closer than a predefined threshold, etc.

The connection channel generator 120 may determine a first category of a first academic literature and cluster a first user corresponding to the first author of the first academic literature and a second user belonging to the first category into a relationship having a research relationship. Without limiting the above description, the research relationship between the first user and the second user may be determined.

The connection channel generator 120 may categorize a first user and a second user into a same group, corresponding to the authors included in the academic literature belonging to the first category. The first user and the second user belonging to the same group may be grouped together and utilize a connection channel directly to each other. Here, the connection channel is a pre-registered connection that may include sending messages, joining video meetings, receiving reminders of upcoming events, viewing current affiliation information, etc.

As illustrated, the connection channel generator 120 may categorize users into categories such as ELM, CoGe, LLMAG, EGVM, MLLM, LM&MA, LM&Ro, ObjD, VLM, and the like. The connection channel generator 100 may assign a user to a group of VLMs according to a predetermined procedure when a user belonging to an ELM wants to establish a connection channel with a user in a group of VLMs.

According to embodiments of the present disclosure, the connection channel generator 100 may categorize at least one author of academic literature newly acquired into preset groups based on data of academic literature newly acquired. the connection channel generator 100 may make channel connection between users in a group.

The connection channel generator 100 may charge a fee to at least one user who wish to join the preset groups without publishing academic literature online. The at least one user may subscribe to the subscription program. The at least one user may also acquire connection channels to a group to which the at least one user does not belong through the subscription program.

The connection channel generator 120 may provide customized services, such as a publication event management function.

The connection channel generator 120 may perform a function of managing a publication event. The publication event management function is a service requested by a user who wishes to an academic literature to be presented. The publication event management function refers to a service that generates an invitation list based on the academic literature. The publication event management function automatically generates an invitation message to each user included in the invitation list. The publication event management function may determine a category of the academic literature based on an embedding vector of the academic literature to be presented. The publication event management function may manage the category of the academic literature and the author of the academic literature. The publication event management function may collect the responses to the invitation message, and manage at least one attendee who have notified attendance and at least one non-attendee who have notified non-attendance.

In further embodiments, the connection channel generator 120 may recommend or generate a function to manage a publication event. For example, the connection channel generator 120 may execute the publication event management function for a publication event of an academic literature. The connection channel generator 120 may generate an invitation list for the publication event, and notify an account of the user of the academic literature to be presented.

According to one embodiment of the present disclosure, the connection channel generator 120 may, in response to the presentation event management request signal, search for one or more academic literatures related to the academic literature to be presented, and generate an invitation list of an authors of the one or more academic literatures. The one or more academic literatures related to the academic literature to be presented may be searched using an artificial intelligence model. Outputting an embedding vector of the academic literature to be presented, and generating one or more academic literature having a difference between the embedding vector and a preset threshold as a relevant academic literature. Wherein, the preset threshold is a threshold value set for a relevance value between literatures, which may be a higher value for more relevant literature and a lower value for less relevant literature. The threshold may be changed by the researcher of the published literature.

The connection channel generator 120 may select an academic literature to invite to a first publication event. More specifically, the connection channel generator 120 may select the academic literature to be invited to the first presentation event based on an artificial intelligence model analysis of the academic literature associated with the first publication event. Here, the artificial intelligence model may be a model that is developed by adapting the architecture and training objectives of a large language model.

The connection channel generator 120 may extract author information from each of the at least one academic literature, and generate an invitation list based on the author information. The author information may further include author information. The list of invitees may include a name, an email address, and/or a co-author.

The connection channel generator 120 may generate a video conference corresponding to the publication event. The connection channel generator 120 may send link of the video conference to the user and/or each of the attendees, and process the link to allow the presenter, and attendees. to enter. The connection channel generator 120 may generate and process the video conference via an external service provider server. In response to the publication event, the connection channel generator 120 may generate and manage publication data, information about the user, an invitation list, and/or information about attendees and non-attendees.

The connection channel generator 120 may perform a function of processing discussion events. The connection channel generator 120 may receive input from a user about a discussion event and process the discussion event based on an discussion data. In another embodiment, the connection channel generator 120 may provide a service of making recommendations about the discussion data. The discussion data may be determined by considering publicly available academic literature, and/or researcher scores. The recommended discussion data may be selected as discussion data in a category that has the highest number of published academic literature in a preset time period, such as in a last one month, a last three months, etc. Among the researchers, the recommended discussion data may be determined from at least one category of at least one author with the highest score. For example, for first, second, and third authors with the highest scores, the discussion data may be selected from a first category to which the first author belongs, a second category to which the second author belongs, and/or a third category to which the third author belongs.

The connection channel generator 120 may input the discussion data to an artificial intelligence model to obtain an embedding vector value of the discussion data. The connection channel generator 120 may search for academic literature having a difference within a preset threshold from the embedding vector value. The connection channel generator 120 may include at least one author of the academic literature in an invitation list of the academic discussion event. The connection channel generator 120 may generate and send an invitation message to each user included in the invitation list, and receive a reply including attendance. Based on the reply including attendance, the academic discussion event may be managed by categorizing users of the invitation list into attendees and non-attendees. The connection channel generator 120 may send a link to a video conference to a user and at least one attendee of the academic discussion event to enter the video conference. The connection channel generator 120 may generate and process the video conference through an external service provider server. In response to the academic discussion event, the connection channel generator 120 may generate and manage discussion data, information about the requesting user, an invitation list, and information about at least one attendee who have notified attendance and at least one non-attendee who have notified non-attendance.

The calculating a relevance between first and second academic literatures may be calculated by comparing first group of first author belonging to a category of the first academic literature and second group of second author belonging to a category of the second academic literature. For example, the number of authors in both the first group and the second group may be counted, and the ratio of the number of authors to the total number of authors may be the relevance between the first and second academic literature. For example, if there are 100 authors belonging to the first group, 120 authors belonging to the second group, and 30 authors belonging to both the first and second groups, the relevance between the first and second academic literatures may be calculated as the number of duplicate users/(total number of users), i.e., the relevance between the first and second literatures is 30/(100+120−30)=0.157. If the number of users in a third group belonging to a third academic literature is 70, and the number of authors. Belonging to both the first and third groups is 40. The relevance between the first and third academic literatures is calculated as the number of duplicate users/(total number of users), which can be 40/(130)=0.307. In the above case, the first academic literature has a higher relevance to the third academic literature than the second academic literature. If a minimum relevance value is set to 0.25, the third academic literature having a relevance value above the minimum relevance value may be determined to be related to the first academic literature, and the second academic literature may be determined to be unrelated to the first academic literature. According to embodiments of the present disclosure, the connection channel generator 120 may select one or more academic literatures related to the predetermined academic literature.

The connection channel generator 120 may calculate an evaluation score for each of academic literatures registered. The academic literature may be converted into rank data based on an evaluation score. The connection channel generator 120 may calculate the evaluation score for each academic literature based on the similarity of each academic literature to a category of academic literature, and a quality score for each academic literature. For example, the evaluation score of a first academic literature belonging to a first category may be calculated by weighted average of the similarity of the first category to the first academic literature and the quality score of the first academic literature itself. The evaluation score of a second academic literature belonging to both the first and second categories may be calculated by weighted average of the similarity of the first category to the second academic literature, the similarity of the second category to the second academic literature, and the quality score of the second academic literature itself.

The quality score of each academic literature may be determined based on at least one of: the number of times the literature is cited, the number of times the academic literature is cited, the number of times the academic literature is cited, the number of academic literature authored by the authors, the number of publication events submitted by the authors of the academic literature, the number of discussion events, the number of users participating in the publication events, the number of users participating in the discussion events, the length of the body of the academic literature, the resolution of the images included in the academic literature, and the number of authors of the academic literature. The higher the length of the text, the higher the resolution of the image, and the higher the number of authors, the higher the quality of the academic literature may be determined. The quality of the academic literature may be determined based on, but not limited to, the data contained in the academic literature.

The connection channel generator 120 may, in response to at least one publication event and at least one discussion event, send a reminder message to the accounts of users to participate in each event. The connection channel generator 120 may send upcoming event information of interest associated with the publication event, the discussion event, and the like to the accounts of participants in the respective events. The connection channel generator 120 may determine the event information of interest based on data collected from the LLM. The LLM may be trained using real-time data input. The LLM may be reinforcement trained using prompts and responses to prompts entered by authors.

The large language model (LLM) may generate responses to user prompts using content extracted from a plurality of webpages, wherein data of the plurality of webpages is retrieved via a separate web-crawling module and provided to the LLM as contextual input.

The connection channel generator 120 may collect data including invitees, attendance response information, actual attendance, attendance time information, and/or activity information during attendance from a publication event or discussion event. The connection channel generator 120 may execute an automation module that handles a follow-up process (procedure, step, task, etc.) for the publication event, the discussion event, and the like.

The automation module may be implemented to handle a detection phase of the event, a data generation phase, and an event processing phase. In the event detection phase, the automation module may detect an event generation signal by a user request, such as a keyboard input, a mouse input, or the like. In the data generation step, the automation module may generate data associated with the event in response to the event generation signal. The data associated with the event may include a type of event and a processing method based on the type of event.

If the type of event is a presentation event, the automation module may create a first thread that generates an invitation list related to an academic literature being presented; a second thread that generates a video conference corresponding to the publication event; a third thread that sends invitation messages to user accounts included in the invitation list, obtains responses to the invitation messages, and stores a list of attendees and non-attendees as data in response to the responses; and a fourth thread that runs following the publication event.

The first thread may be implemented to generate an invitation list associated with the academic literature. The first thread may generate the invitation list based on the academic literature being presented and the authors of at least one academic literature related to the academic literature.

The second thread may be implemented to generate video conference data corresponding to the event. The second thread may generate data for the video conference, including the presenter of the event, the academic literature presented, a schedule, and attendees, and may process the video conference to be activated in accordance with a predetermined schedule. A second thread can be implemented to collect information about attendees entering the video conference.

The third thread may be implemented to send invitation messages to each user account on the invitation list and process responses to the invitation messages. The third thread may record attendance or non-attendance information in the invitation message and store the information separately for attendees and non-attendees. The third thread is accounts of the attendees, which may be used to send conference invitations, or reminders according to the schedule of the video conference. Through the third thread, each user account on the invitation list may be tracked for response, and/or attendance. An information of the response or attendance may be used as data for user accounts such as authors. The number of times each user has attended as a speaker, the number of times each user has responded as an attendee, the number of times each user has actually attended, and the time value of user's attendance may be used to calculate an activity score for each user account. The greater the number of times each user has attended as a speaker, the greater the number of times each user has responded as an attendee, the greater the number of times each user has actually attended, and the longer the time spent in attendance, the higher the activity score for the user's account. The number of times each user speak in a publication event may also affect each user account's activity score. The higher the number of speeches, the higher the activity index of the user's account may be determined.

The fourth thread may be implemented to send a message, following a publication event, requesting feedback information about the event. The fourth thread may receive the message. The fourth thread may store and manage feedback information about past announcement events. The threads created in response to the publication event may terminate when the publication event is complete, and only data processed by the threads is stored.

If the type of event is an discussion event, the automation module may create a first thread that creates an invitation list associated with the discussion event, a second thread that creates a video conference corresponding to the announcement event, a third thread that sends invitation messages to user accounts included in the invitation list, obtains responses to the invitation messages and stores the list of attendees and non-attendees as data in response to the responses, and a fourth thread that runs after the event. The threads generated in response to the event are executed, terminating when the event is completed, and only the data processed by the threads is stored.

The connection channel generator 120 may calculate at least one of an activity score and an evaluation score of each user in consideration of the research performance performed by each user, and may set a user's grade based on the activity score and the evaluation score. The research performance may include, for example, publications, patent activity, presentation events, categories of publications, co-authorships, and the like. The activity score may be calculated based on at least one of: the number of publications in which the user is listed as an author, the number of categories of publications, and the amount of change in the number of publications in which the user is listed as an author. A user's grade may be calculated by weighting the quality value of each academic literature to produce a user's grade for academic literature for which the user is registered as an author. The user's grade may be determined as one of a high, medium, low, or the like, based on a predetermined table. The connection channel generator 120 may determine a user's grade in an order of the index values corresponding to the ratings of the users.

The connection channel generator 120 may set a user's grade based on an activity score, an evaluation score, or the like of each of one or more users belonging to the group. The grade of each user may be set to a predetermined level based on a preset table.

The connection channel generator 120 may differentiate the activity of the user in the connection channel based on the grade of the user in the group. The connection channel generator 120 may provide access to all services in the connection channel for users of a higher level, access to services of webinars, messaging, and collaboration tools for users of a middle level, and access to services of messaging and collaboration tools for users of a lower level. Without limitation, the number of services provided may be differentiated based on the tier of the user.

The connection channel generator 120 may convert each of the academic literatures into a point and output trend data such as changes in the frequency of occurrence of keywords in the academic literatures, changes in the number of categories, changes in the number of authors, etc.

The connection channel generator 120 may generate trend data based on at least one of a number of published academic literatures, a change in the frequency of occurrence of keywords in the academic literatures, an increase or decrease in the number of categories, a change in the number of users as authors, and a value of the quality of the academic literatures, in a time series order.

In further embodiments, the connection channel generator 120 may calculate embedding vectors for each of the plurality of academic literatures, transform the embedding vectors into coordinates in vector space to form a set of points in a multidimensional space, and calculate a mean vector or a center vector of the set of points as a single representative point. The connection channel generator 120 may analyze the movement of the embedding vectors over time or publication order to output the trend data about the academic literatures.

In optional embodiments, the connection channel generator 120 may output trend data for the academic literatures. The connection channel generator 120 may output the trend data based on a number of authors of the academic literatures.

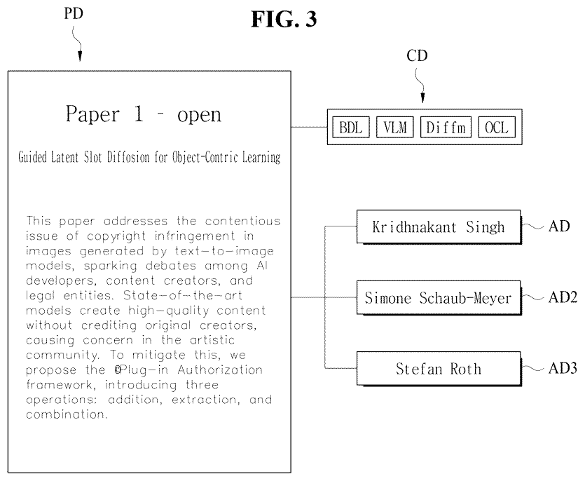

FIG. 3 illustrates an exemplary diagram of data acquired from an academic literature. According to embodiments of the present disclosure, the connection channel generation device 100 may extract a first author AD1, a second author AD2, and a third author AD3 from the academic literature PD, and may determine a category CD of the academic literature PD based on one or more embedding vector values of the academic literature PD.

As shown in the figure, a category CD of an academic literature PD may be determined as BDL, VLM, DiffM, OCL. An embedding vector value of the academic literature PD may have a difference value with an embedding vector value of the BDL, an embedding vector value of the VLM, an embedding vector value of the DiffM, and an embedding vector value of the OCL, respectively, that is less than or equal to a preset minimum difference value. According to embodiments of the present disclosure, the connection channel generation device 100 may compare the embedding vector values of the body of the academic literature PD and the representative values of the embedding vector values of the body of the one or more academic literatures belonging to the BDL to determine whether a difference between the embedding vector values is less than or equal to a minimum difference value, and if the difference is less than or equal to the minimum difference value, the academic literature PD may be determined to be in the BDL category.

The connection channel generation device 100 may determine whether the difference value between the embedding vector values of the summary of the academic literature PD and the representative values of the embedding vector values of the summary of one or more academic literatures belonging to the BDL is below a minimum difference value by comparing the embedding vector values, and if the difference value is below the minimum difference value, the academic literature PD may be determined to be a BDL category. According to embodiments of the present disclosure, the connection channel generation device 100 may compare the embedding vector values of the author of the academic literature PD and the representative values of the embedding vector values of the author of the one or more academic literatures belonging to the BDL to determine whether a difference between the embedding vector values is less than or equal to a minimum difference value, and if the difference is less than or equal to the minimum difference value, the academic literature PD may be determined to be in the BDL category.

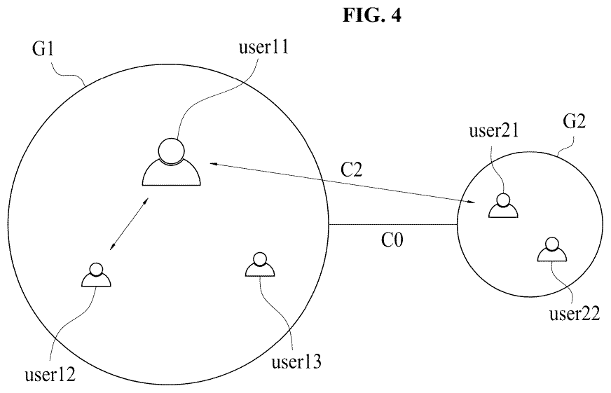

FIG. 4 illustrates a diagram explaining connection channels among a plurality of users classified into two groups.

According to embodiments of the present disclosure, authors of academic literatures—namely user11, user12, user13, user21, and user22—may be classified into two groups. The connection channel generation device 100 may utilize a LLM to classify a first academic literature, a second academic literature, and a third academic literature into a same category, and may classify user11, user12, and user13, the respective authors of these documents, into a first group G1.

In a similar manner, the connection channel generation device 100 may classify a fourth and fifth academic literatures into a same category and may assign their respective authors, user21 and user22, to a second group G2.

The connection channel generation device 100 may establish a first connection channel C1 between the first user user11 and the second user user12 belonging to the first group. The first connection channel C1 may be configured to provide pre-designated services such as video conferencing, webinars, messaging, and collaboration tools between users in a same group. The services provided via the first connection channel C1 may be configurable by an administrator.

According to embodiments of the present disclosure, the connection channel generation device 100 may establish a second connection channel C2 between a first user 11 belonging to a first group and a fourth user 21 belonging to a second group.

The connection channel generation device 100 may determine whether there is a research relationship between a first group G1 and a second group G2. The first group G1 and the second group G2 having a research relationship may be connected by C0. The connection channel generation device 100 may determine whether there is a research relationship based on whether the authors of the academic literatures belonging to the first group G1 and the authors of the academic literatures belonging to the second group G2 are the same. The first and second groups that have a research relationship can be connected by C0. C0 may be set to provide more services in proportion to the number of identical authors. The second connection channel C2 enables preset services to be provided. Here, the second connection channel C2 may be set to provide fewer services than the first connection channel C1.

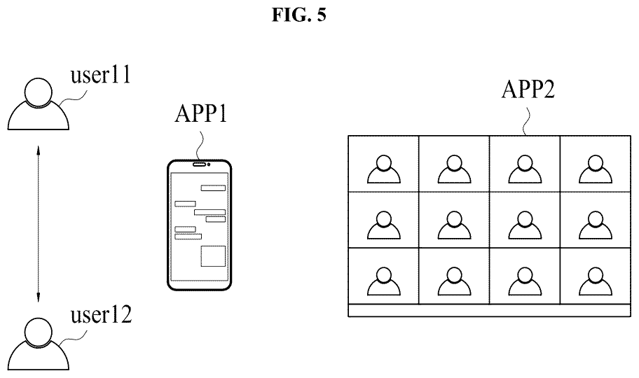

The type of service provided in the second connection channel C2 may be determined based on an evaluation score of the second group. The evaluation score of the second group may be calculated as the sum of the evaluation scores of users belonging to the second group. FIG. 5 illustrates a diagram explaining services provided via the first connection channel.

Between the first user user11 and the second user user12, messaging services APP1 and video conferencing services APP2 may be provided via the first connection channel.

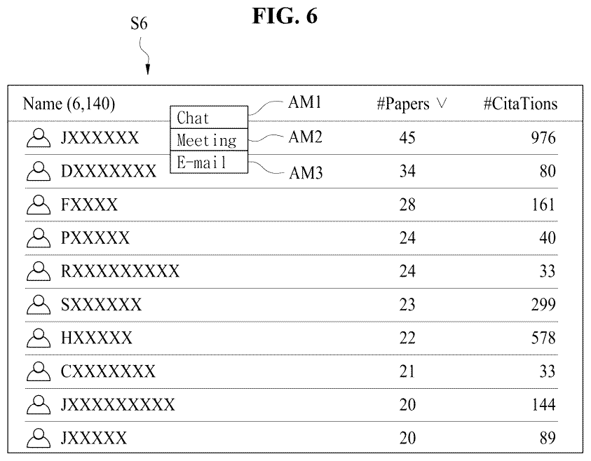

FIG. 6 illustrates an exemplary user interface of a user list.

According to embodiments of the present disclosure, the connection channel generation device 100 may provide a user list interface S6 for the registered users.

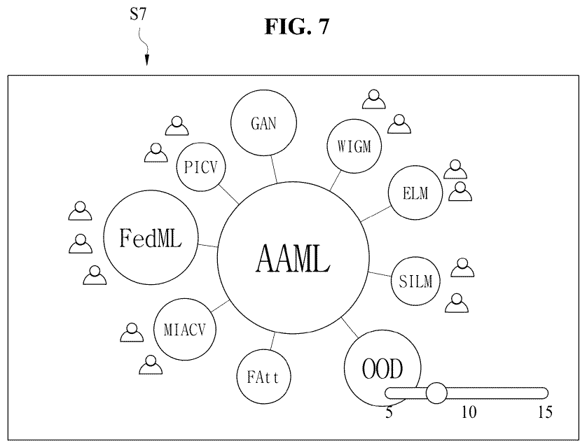

The connection channel generation device 100 may provide information about users belonging to the same group in a user interface of the user list. The user interface of a pop-up screen of services associated with each user in the user list may be provided. The user interface of the pop-up screen may include a user, a messaging service, a video conferencing service, and an email sending service. A messaging service AM1 may be provided by navigating to a messaging application with the corresponding user. Selecting a video conferencing service AM2 may be provided by navigating to the user and the video conferencing service application. If a user select an email Service AM3, the user may be directed to the user and the email service application. FIG. 7 illustrates an exemplary diagram of a category display user interface S7 provided according to embodiments of the present disclosure.

In the category display user interface S7, categories may be displayed, including the size of the categories and the connections between the categories.

The size of the dialogs corresponding to the categories may be proportional to the number of literatures belonging to the category and/or the number of authors belonging to the category. The size of the dialog corresponding to each category may be adjusted to account for the quality of the respective literatures. For example, if a first academic literature belongs to both a first category and a second category, and the relevance of the first category is 80% and the relevance of the second category is 20%, the first academic literature may be multiplied by a weighting factor of 0.8 when counted in the first category, and the second academic literature may be multiplied by a weighting factor of 0.2 when counted in the second category.

According to embodiments of the present disclosure, the connection channel generation device 100 may analyze the academic literatures to determine categories of the academic literatures, and may determine the size of the dialog corresponding to the category by considering the number of academic literatures belonging to each of the categories. The color of the dialog corresponding to each category may be set differently for each category. The relationship between the categories may be established by the degree of equivalence between the authors of the literatures belonging to the categories, and/or the degree of relevance of the academic literatures. According to embodiments of the present disclosure, the connection channel generation device 100 may establish a relationship between AAML and OOL based on the degree of equivalence between authors of academic literatures belonging to AAML and authors of academic literatures belonging to OOD (e.g., the number of identical authors) and/or a degree of overlap between the academic literatures. Here, the degree of overlap may be calculated by considering the proportion, number, and/or quality of literatures in the AAML that are also in the OOL. The higher the proportion of academic literatures belonging to both AAML and OOL, the larger the number of academic literatures, and the higher the quality of the overlapping literatures, the greater the relationship between AAML and OOL. The higher the degree of homogeneity among the authors of the publications, the higher the degree of the relationship may be calculated.

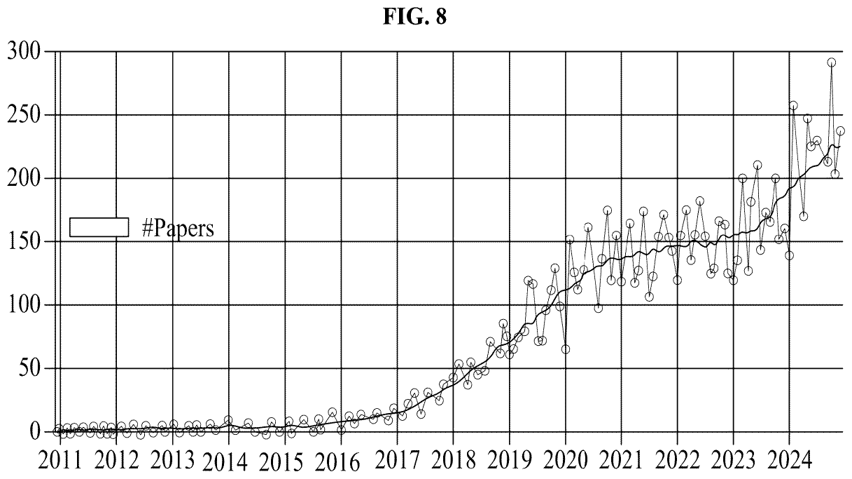

In this way, the relationship between AAML and Fatt, MIACV, FedML, PICV, GAN, SILM, ELM, WIGM, etc. may be established. FIG. 8 illustrates an exemplary diagram of trend data provided according to embodiments of the present disclosure.

The connection channel generation device 100 may generate and provide trend data representing the chronological variation of academic literatures belonging to a category.

The trend data for a group may include variations in the number of academic literatures published by one or more users belonging to the group, an average number of authors per document, an average quality of the academic literatures, and variations in the number of users belonging to the group.

The trend data for academic literatures may include changes in the frequency of keyword occurrences, changes in the number of documents per category, and variations in the number of users who are listed as authors of the academic literatures.

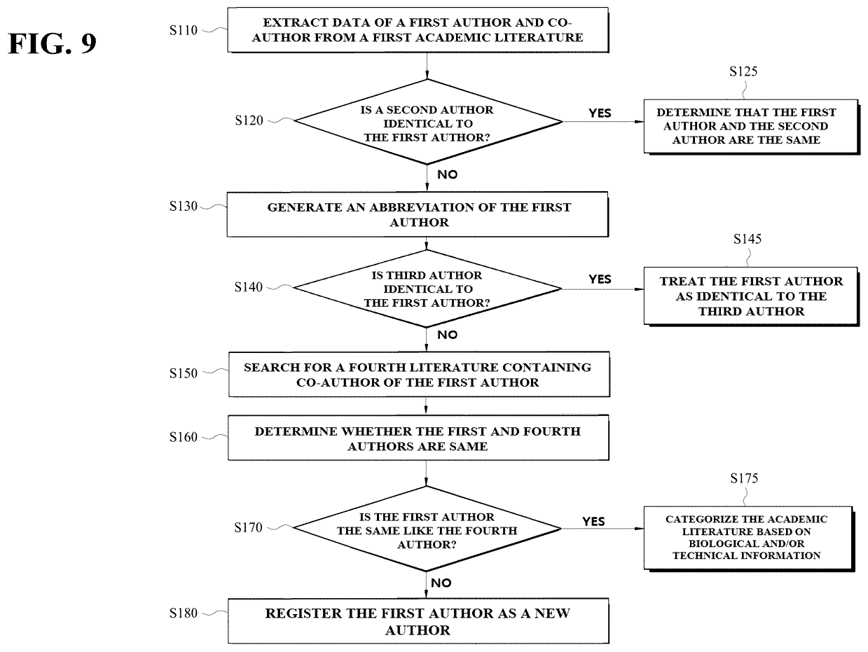

FIG. 9 is a flowchart illustrating a method for determining author identity according to embodiments of the present disclosure.

In step S110, the connection channel generation device 100 may extract data of a first author and co-author from a first academic literature.

In step S120, the connection channel generation device 100 may search for a second author identical to the first author among at least one authors of pre-registered academic literatures. The connection channel generation device 100 may extract text corresponding to an author from the data of registered academic literatures and/or academic literatures, and store the extracted text as data of the academic literatures. The connection channel generation device 100 may retrieve, from the data of the academic literature, an academic literature of a second author identical to the first author. The connection channel generation device 100 may retrieve an academic literature comprising a second author whose embedding vector matches the embedding vector of the first author.

In step S125, if the second author identical to the first author is found, the device 100 may determine that the first author and the second author are the same.

In step S130, if no identical second author is found, the device may generate an abbreviation of the first author and calculate the embedding vector of the abbreviated name.

In step S140, the device 100 may search for a third author identical to the abbreviated form of the first author in the registered author data. The connection channel generation device 100 is an embedding vector of an abbreviated form of the first author, and may retrieve the academic literature of the third author and the third author.

In step S145, if a match is found, the device may treat the first author as identical to the third author. The connection channel generation device 100 may set the first author to be the same as the third author.

In step S150, if no identical author is found, the device may search for a fourth author by using co-authors of the first author and retrieve a fourth literature containing the fourth author. A second reference to a fourth author is one or more academic literatures that include the second author as an author.

In step S160, the device may determine whether the first and fourth authors are the same based on the information of the first and second academic literature. The connection channel generation device 100 may determine whether the first author and the fourth author are the same person or whether the first author and the fourth author are the same author. The connection channel generation device 100 may determine that the first author and the fourth author are the same if the first academic literature of the first author and the fourth academic literature of the fourth author are in the same category. The connection channel generation device 100 may determine that the first category of the first literature and the fourth category of the fourth literature are similar if a distance value (cosine value) between an embedding vector of the first category of the first literature and an embedding vector of the fourth category of the fourth literature is below a preset threshold value.

In step S170, the connection channel generation device 100 may determine whether the first author and the second author are the same based on a distance value between the embedding vector of the first category of the first academic literature of the first author and the embedding vector of the fourth category of the fourth academic literature of the second author.

In step S175, the connection channel generation device 100 may categorize the academic literature based on biographical information and/or technical information if the first author and the fourth author are the same. The connection channel generation device 100 may input data about the first academic literature to the LLM to output an embedding vector value of the first academic literature. The connection channel generation device 100 may input the summary data into the first LLM to output an embedding vector value of the summary data. The connection channel generation device 100 may input the title data into the second LLM and output an embedding vector value of the title data. The connection channel generation device 100 may input the body data into a third LLM and output a third embedding vector value of the body data. The connection channel generation device 100 may compare the embedding vector value of the summary data with the category-specific representative embedding vector value preset for the summary data, and determine the category of academic literature with the embedding vector value having a distance value closest to the embedding vector value as the first category of academic literature. The connection channel generation device 100 may compare the embedding vector value of the title data with the preset category-specific representative embedding vector value set for the title data, and determine the category of academic literature having the embedding vector value with the closest distance value to the embedding vector value as the category of the first academic literature. The connection channel generation device 100 may compare the embedding vector value of the body data with the category-specific representative embedding vector value preset for the body data, and determine the category having the embedding vector value with the closest distance value to the third embedding vector value as the category of the first academic literature. The connection channel generation device 100 may determine at least one category corresponding to the embedding vector value of the summary data, the category corresponding to the embedding vector value of the title data, and the category corresponding to the embedding vector value of the body data as the category of the first academic literature.

In step S180, the connection channel generation device 100 may register the first author as a new author if the first author and the fourth author are not the same. The person classification model may register an author of the academic literature using an embedding vector of the academic literature and an embedding vector of the author of the academic literature. Registering an author means registering an author as an existing object or a new object.

In another embodiment, the connection channel generation device 100 may compare and analyze author data having the same or similar meta-information in a plurality of registered academic literatures based on textual data including meta-information such as the first author's name, affiliation, email address, and the like included in the first academic literature, and search for an author identified as the same author as the first author. The connection channel generation device 100 may perform a normalization process on the name information of the first author and search for author data that is determined to be the same author as the first author using a character similarity, and/or an affiliation match with each registered author of the academic literature. The connection channel generation device 100 may store and manage meta-information such as the author's name, affiliation, email address, and the like as author information of the academic literature. According to one embodiment of the present disclosure, the connection channel generation device 100 may categorize academic literatures into embedding vectors for each of the academic literatures, identify each of the authors of the academic literatures using LLMs, and provide groups, in-group services, etc. that include a plurality of researchers belonging to a technical field based on the embedding vectors of the academic literatures and the identification information of the authors of the academic literatures. The connection channel generation device 100 may be utilized by learning LLMs different for each technical field. According to embodiments of the present disclosure, the connection channel generation device 100 may categorize published academic literature on the latest advances in technology fields such as AI, quantum mechanics, autonomous driving, blockchain, secondary batteries, and/or bio-artificial intelligence, and generate and manage clustered data on researchers in such technology fields based on the published academic literature. Embodiments of the present disclosure utilize artificial intelligence models to analyze the published academic literature. The AI model may evolve to utilize other algorithms as technology develops, and may be a LLM trained on a base based on a transformer model. According to embodiments of the present disclosure, the connection channel generation device 100 may cluster aggregated users (researchers, authors) based on author information for academic literatures. By clustering the academic literatures based on the embedding vector values, the connection channel generation device 100 can analyze the data by category and generate data about researchers that reflects the latest development trends. The connection channel generation device 100, according to embodiments of the present disclosure, facilitates research collaboration, knowledge sharing, and/or technology convergence by creating automated connection channels between researchers in the same or similar technical fields. The connection channel generation device 100 may utilize LLMs that are custom trained through a process of training with academic literatures in each technology field, thereby improving the accuracy of classification and increasing consistency of topics. By automatically analyzing the content reflected in the latest academic literature in real time and updating the researcher information, the connection channel generation device 100 can accumulate data that is sensitive to technology trends. Through the connection channel, a user can set up to provide discussion channels, research suggestions, information curation services, etc. Users can handle events such as discussion channels and/or research proposals, and determine the categories of discussion channels and/or research proposals, and provide messages, video services, etc. to users belonging to groups in the categories. As described above, the disclosure has been described with reference to the embodiment illustrated in the drawings, but this is merely an example. Those of ordinary skill in the art will fully understand that various modifications and other equivalent embodiments can be made from the embodiments. Therefore, the scope of the protection of the technology of the disclosure should be determined by the appended claims.

Specific technical descriptions in the embodiments are embodiments and do not limit the technical scope of the embodiments. In order to concisely and clearly describe the disclosure, descriptions of general techniques and configurations of the related art may be omitted. Also, connections or connection members of lines between elements illustrated in the drawings are examples of functional connections and/or physical or circuit connections, and may be represented by various alternative or additional functional connections, physical connections, or circuit connections in an actual device. In addition, unless specifically stated as “essential” or “importantly”, an element may not be a necessary element for the application of the disclosure.

The term “above” or similar referring expressions used in the description and claims of the disclosure may refer to both the singular and plural expressions unless otherwise specified. Also, when a range is described in the embodiments, it means that embodiments to which individual values belonging to the range are applied are also included unless otherwise stated, it is the same as each individual value constituting the range is described in the detailed description of the disclosure. Moreover, steps or operations constituting the method according to the embodiments may be performed in an appropriate order, if the order is explicitly stated or unless otherwise stated. The embodiments are not necessarily limited according to the order of the description of the steps or operations. All examples or illustrative terms e.g., etc. in the embodiments are merely used to describe the embodiments in detail, and the scope of the embodiments is limited by the examples or illustrative terms unless limited by the claims. In addition, those of ordinary skill in the art will appreciate that various modifications, combinations, and changes can be made in accordance with design conditions and factors within the scope of the appended claims or equivalents thereof.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope included in the following claims.

What is claimed is:

1. A method for generating a connection channel, comprising:
obtaining, by a connection channel generation device, one or more academic literatures published on a registered website;
obtaining, by the connection channel generation device, text included in a file of a first academic literature among the one or more academic literatures, classifying the text by at least of field, and inputting data of a first field among the at least one field into a first large language model to output a first embedding vector value;
determining, by the connection channel generation device, a category of the first academic literature based on the first embedding vector value; and
classifying, by the connection channel generation device, classifying a first user associated with the first academic literature into a group based on the category of the first academic literature; and
generating, by the connection channel generation device, a connection channel providing a messaging service between the first user and a second user within the group.

2. The method of claim 1, wherein generating the connection channel comprises:
classifying the second user, having a research relationship with the first user, into the group based on one or more academic literatures classified in the same category as the first academic literature; and
automatically generating a connection channel between the first user and the second user.

3. The method of claim 1, wherein determining the category comprises:
comparing the first embedding vector value of the first academic literature with one or more category-specific representative embedding vector values and determining a category of a representative embedding vector value having a distance equal to or less than a predetermined threshold as the category of the first academic literature.

4. The method of claim 1, wherein outputting the first embedding vector value comprises:
inputting data of a second field of the first academic literature into a second large language model to output a second embedding vector value, and
outputting a final embedding vector value by applying weighting values to the first and second embedding vector values.

5. The method of claim 1, further comprising:
executing, by the connection channel generation device, a separate program that provides at least one service among video conferencing, webinar, messaging, and collaboration tools between a terminal of the first user and a terminal of the second user through the generated connection channel.

6. The method of claim 1, further comprising:
receiving a connection channel generation request from a third user who has no research relationship with the first user, and
transmitting an approval request for the connection channel generation request based on a service level of the third user.

7. A connection channel generation device comprising a processor, a memory, and a communication module, wherein the processor is configured to:
obtain one or more academic literatures published on a registered website;
obtain text included in a file of a first academic literature among the one or more academic literatures, and classify the text by at least one field, and input data of a first field among the at least one field into a first large language model to output a first embedding vector value;
determine a category of the first academic literature based on the first embedding vector value;
classify a first user associated with the first academic literature into a group based on the category of the first academic literature; and
generate a connection channel providing a messaging service between the first user and a second user within the group.

8. The device of claim 7, wherein the processor is further configured to:
classify the second user, having a research relationship with the first user, into the group based on one or more academic literatures classified in the same category as the first academic literature, and
automatically generate a connection channel between the first user and the second user.

9. The device of claim 7, wherein the processor is further configured to:
compare the first embedding vector value of the first academic literature with one or more category-specific representative embedding vector values and determine a category of a representative embedding vector value having a distance equal to or less than a predetermined threshold as the category of the first academic literature.

10. The device of claim 7, wherein the processor is further configured to:
input data of a second field of the first academic literature into a second large language model to output a second embedding vector value, and output a final embedding vector value by applying weighted averaging to the first and second embedding vector values.

11. The device of claim 7, wherein the processor is further configured to:
execute a separate program that provides at least one service among video conferencing, webinars, messaging, and collaboration tools between a terminal of the first user and a terminal of the second user through the generated connection channel.

12. The device of claim 7, wherein the processor is further configured to:
receive a connection channel generation request from a third user who has no research relationship with the first user, and
transmit an approval request for the connection channel generation request based on a service level of the third user.

13. A computer-readable storage medium storing a program that, when executed by a computer, causes the computer to perform the method according to claim 1.
